(19) United States
(12) Patent Application Publication
(10) Pub. No.: US 2015/0226151 A1
(43) Pub. Date: Aug. 13, 2015

(54) PISTON OF TWO-PIECE CONSTRUCTION FOR AN INTERNAL COMBUSTION ENGINE

(71) Applicant: KS KOLBENSCHMIDT GMBH, Neckarsulm (DE)

(72) Inventors: Ottliczky Emmerich, Neckarsulm (DE); Eberhard Weiss, Neckarsulm (DE); Gerhard Luz, Neckarsulm (DE); Willi Sikorsky, Neckarsulm (DE)

(73) Assignee: KS KOLENBENSCHMIDT GMBH, Neckarsulm (DE)

(21) Appl. No.: 14/431,635

(22) PCT Filed: Sep. 18, 2013
(86) PCT No.: PCT/EP2013/069368

§ 371 Date: Mar. 26, 2015

(30) Foreign Application Priority Data
Sep. 27, 2012 (DE) 10 2012 217 599.7

(51) Int. Cl. F02F 3/18; F01P 3/06; F02F 3/00

(52) U.S. Cl. CPC F02F 3/18; F02F 3/003; F01P 3/06; F02F 2003/0061; F02F 2003/0053

(57) ABSTRACT

The invention relates to a piston (1) for an internal internal combustion engine, configured as a gallery-cooled piston of two-piece construction which comprises a main body (2) and a ring element (3). The ring element (2) which has a ring zone (18) and a fire land (17) encloses a cooling gallery (15) on the outside, which cooling gallery (15) is delimited on the inside by an intermediate wall (16) which separates the cooling gallery (15) from a combustion-chamber recess (12) which is made in a piston head (10) of the main body (2). The main body (2) and the ring element (3) together form two circumferential dividing planes (4a, 5a) which are offset with respect to one another, to which end in each case two interacting joining webs (6a, 6b; 7a, 7b) of the ring element (3) and of the main body (2) are connected with a material-to-material bond.

The invention relates to a piston for an internal combustion engine, configured as a two-piece gallery-cooled piston that comprises a main body and a ring element in accordance with the preamble of claim 1. The present invention further relates to a method for producing such a piston in accordance with claim 9.

The piston for internal combustion engines is exposed to high thermal stresses and high alternating mechanical stresses caused by gas and mass forces that require suitable dimensioning and design. Severely stressed zones of the piston, for example the combustion bowl in the piston crown and the ring zone, require effective cooling. To this end it is known to integrate a cooling gallery in the piston. A cooling medium, preferably the lubricating oil for the internal combustion engine, circulates through the cooling gallery cavity. The efficacy of piston cooling is determined in particular by the volume of cooling medium exchanged in the cooling gallery.

A two-piece piston is known from DD 123 962 A1 comprising a main body and a ring element. The separate, circular ring element, which comprises the top land and the ring zone of the piston and delimits the cooling gallery to the outside, is attached to the main body by means of a screw thread. The ring element is fixed in position in the installed state by means of dowels or threaded pins that are used between the main body and the ring element. U.S. Pat. No. 6,155,157 discloses a cooling gallery piston with two components that can be produced separately and then joined in a material-to-material bond using friction welding.

The object of the present invention is to create a two-piece cooling-gallery piston that includes a permanent connection of the individual components.

This object is achieved by the ring element and the main body jointly forming two circumferential dividing planes offset to each other to which end two respective corresponding interacting joining webs of the ring element and of the main body are joined in a material-to-material bond. The ring element is supported on dedicated joining webs of the main body through two joining webs positioned in different locations and offset in height. This design principle permits a piston construction with which a permanent joining of the individual piston components can be realized. At the same time the concept has the advantage of optimizing the cooling gallery through appropriate design of the ring element to improve piston cooling and to realize a piston that can tolerate higher thermal loads.

Additionally, using this invention, the construction or the design of the separate ring element, in particular with respect to wall thicknesses of individual piston sections, can be manipulated to reduce piston weight for example. The possibility further exists of optimizing the top land, the ring zone or the ring carrier of the ring element. In accordance with the invention, this construction offers the possibility of locating the dividing planes between the main body and the ring element in such a way that an optimal location results with respect to component strength and/or welding.

The invention further offers the possibility of specially configuring the thermally and mechanically highly stressed ring element. The ring element comprising the top land and the ring zone for the piston rings can be optimized with respect to durability and wear resistance.

In accordance with an advantageous embodiment of the invention, no defined position for the dividing planes is provided. The interacting, circumferential dividing planes can be advantageously configured in such a way that they are both offset to each other and aligned diverging from each other.

Depending on the layout criteria, for example optimal cooling gallery design, an optimized location for welding or taking strength into consideration, a piston can comprise matching or differently shaped dividing planes. Accordingly, the invention offers the opportunity of providing two dividing planes between the ring element and the main body, offset in height, of which one can run vertically and the other horizontally.

The invention further comprises a piston in which at least one of the two dividing planes is aligned obliquely, or inclined. With two inclined dividing planes they can run in the same direction or counter to each other. Advantageously there is no specification for the direction for the respective dividing plane. With dividing planes inclined in opposite directions, a centering effect of these components can continue to be used when the ring element and the main body are joined.

For a piston design with one vertical and one horizontal dividing plane, a vertically aligned dividing plane is preferably provided in the piston crown between the ring element and the main body and a horizontally aligned dividing plane is provided below the ring zone of the ring element. A maximum vertical offset results between the two dividing planes with this piston construction.

In accordance with a further embodiment of the invention, the main body forms a circumferential step on the outside whose joining web running concentric to a longitudinal axis of the piston is enclosed by the joining web of the ring element to form a vertical dividing plane. In this embodiment the length of the dividing plane can be advantageously affected by the axial length of the step, or ledge, wherein this concept simultaneously brings about a centering effect on the components when they are joined.

An advantageous embodiment of the invention further provides for the matching, interacting joining webs of the ring element and of the main body to have constant wall thicknesses. The effect of joining webs with at least approximately identically dimensioned wall thicknesses is a desirable optimal equalization of tension, or distribution of tension in the piston upper part.

The invention furthermore offers the advantage of producing the ring element and the main body from an identical material or from different materials. A multi-piece piston provides this advantage, wherein the choice of material can be made with respect to the particular thermal and/or mechanical stress. The ring element is preferably produced from a hard wearing, specifically thermally stable material. In order to save weight, a less hard wearing material, a light alloy for example, can be chosen as the material for the main body.

In order to achieve the object, a method is additionally proposed to produce a piston that comprises the following steps. First of all, a main body and a ring element are produced separately as blanks. These components are preferably produced as forged or cast blanks, by stamping or pressing, from a semi-finished material of a steel material. As an alternative, extrusion, forging or casting is suitable for producing the main body and the ring element. The production process for the main body and the ring element includes forming the joining webs without reworking. The main body and the ring element can be produced from a matching material or from different materials. With the subsequent pre-machining, the combustion bowl and a piston pin bore can be introduced into the main body along with piston ring grooves in the ring belt of the ring element.

Then the main body and the ring element are joined until two respective matching joining webs abut that form two dividing planes offset to each other. The main body is joined to the ring element in a material-to-material bond by subsequent welding of the joining webs.

Different methods can be employed for the material-to-material bond of the main body and the ring element. Preferably, friction welding, or multi-orbital or multi-linear friction welding is used. Alternatively, electron beam welding, resistance press welding, condenser discharge welding or laser welding is suitable. Soldering can be used in addition for material-to-material joining of the matching joining webs. After the welding process is complete, the weld seams that have formed externally are removed. Final machining and cleaning of the piston follows as the last step.

Additional features of the invention can be found in the following description and the drawings which show embodiments of the invention. Unless otherwise stated, identical or functionally identical components are given the same reference numerals.

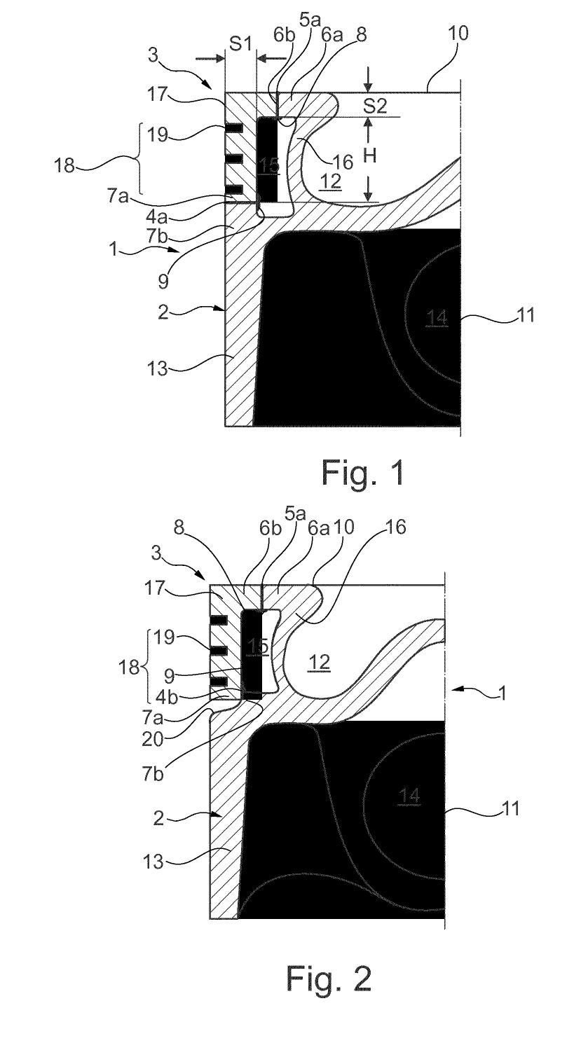

FIG. 1 shows a first embodiment of a piston (1) in accordance with the invention in a sectional view,

FIG. 2 shows a second embodiment of a piston (1) in accordance with the invention,

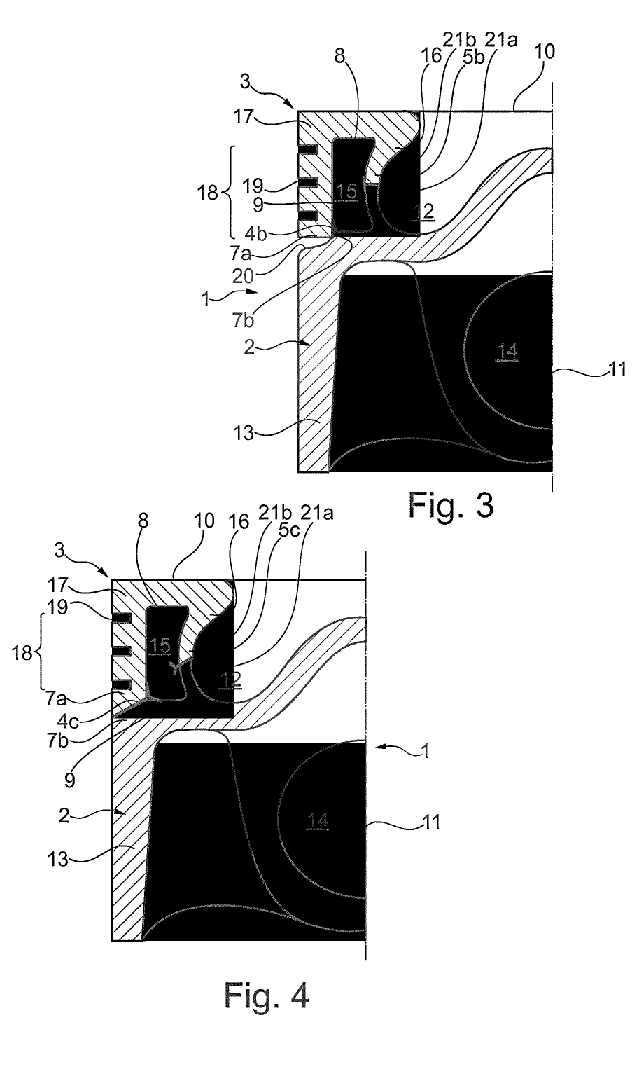

FIG. 3 shows a third embodiment of a piston (1) in accordance with the invention,

FIG. 4 shows a fourth embodiment of a piston (1) in accordance with the invention.

FIG. 1 shows a sectional view of a piston 1 produced as one piece comprising a main body 2 and a ring element 3 that are connected by joining webs 6a, 6b; 7a, 7b forming dividing planes 4a, 5a. The joining webs 6a, 6b; 7a, 7b are joined in a material-to-material bond in the area of the dividing planes 4a, 5a by means of friction welding.

For example, multi-orbital friction welding is employed in which, because of the extremely small, circular orbital movements, no, or only minor, weld beads 8, 9 are formed in the area of the dividing planes 4a, 5a that require no, or only minor, reworking. The wall thickness S₁, S₂ of the joining webs 6a, 6b and the joining webs 7a, 7b is constant as far as possible. A maximum height offset H results between the vertically aligned dividing plane 5a and the horizontally running dividing plane 4a. The main body 2 of the piston 1 includes a combustion bowl 12 introduced into a piston crown 10 eccentric or rotationally symmetrical to a longitudinal axis 11. A piston skirt 13 of the main body 2 includes two diametrically opposed piston pin bores 4 that are intended to receive a piston pin (not shown). An intermediate wall 16 surrounding the combustion bowl 12 delimits a cooling gallery 15 on the inside that is enclosed on the outside by the ring element 3. The cooling gallery 15 is closed circumferentially by the main body 2 with the ring element 3 after welding has been performed. When the engine is operating, a cooling medium can be selectively applied to the cooling gallery 15 through at least one inlet and one outlet (not shown). The ring element 3 has a top land 17 on the piston crown side to which a ring belt 18 is attached with ring grooves 19 that are intended to receive piston rings (not shown).

FIGS. 2 to 4 show alternative embodiments of the piston 1 in accordance with the invention, wherein matching reference numerals are used for identical or identically functioning components. The following descriptions of the Figures are largely limited to differences in features compared with FIG. 1.

In accordance with FIG. 2, the piston 1 includes two vertically aligned dividing planes 4b, 5a between the main body 2 and the ring element 3. Dividing plane 4b is formed by a step 20 of the main body 2 that is enclosed on the outside by an end section of the ring element 3. An overlapping area of the joining webs 7a, 7b of the interacting components, the main body 2 and the ring element 3, defines the dividing plane 4b.

FIG. 3 illustrates shows the piston 1, the construction of which largely matches the illustration in FIG. 2. The piston 1 in FIG. 3 shows, in addition to the dividing plane 4b from FIG. 2, the horizontally running dividing plane 5b assigned to the intermediate wall 16 said planes being formed by the joining webs 21a, 21b. If the components forming the piston 1 are joined axially, the step 20 of the main body 2 can be used to center the ring element 3.

The piston 1 in FIG. 4 comprises two inclined, or oblique, dividing planes 4c, 5c between the main body 2 and the ring element 3. As an alternative to dividing planes 4c, 5c from FIG. 4 that run on a matching incline, it is possible that the dividing planes 4c, 5c run counter to each other.

### LIST OF REFERENCE NUMERALS

1 Piston
2 Main body
4a Dividing plane
4b Dividing plane
4c Dividing plane
5a Dividing plane
5b Dividing plane
5c Dividing plane
6a Joining web
6b Joining web
7a Joining web
7b Joining web
8 Weld bead
9 Weld bead
10 Piston crown
11 Longitudinal axis
12 Combustion bowl
13 Piston skirt
14 Piston pin bore
15 Cooling gallery
16 Intermediate wall
17 Top land
18 Ring belt
19 Ring groove
20 Step
21a Joining web
21b Joining web
S₁ Wall thickness
S₂ Wall thickness
H Height offset

What is claimed:

1. Piston (1) for an internal combustion engine configured as a cooling-gallery piston of two-piece construction that consists of a main body (2) and a ring element (3), wherein the ring element (3) with a ring belt (18) and a top land (17) encloses on the outside a cooling gallery (15) that is delimited on the inside by an intermediate wall (16) that divides the cooling gallery (15) from a combustion bowl (12) introduced into a piston crown (10) of the main body (2), and the ring element (3) is joined in a material-to-material bond to the main body (2), characterized in that the main body (2) and the ring element (3) jointly form two circumferential dividing planes (4a-4c; 5a, 5c) offset to each other, to which end two matching, interacting joining webs (6a, 6b; 7a, 7b; 21a, 21b) of the ring element (3) and the main body (2) are joined in a material-to-material bond.

2. Piston (1) from claim 1, wherein the dividing planes (4a, 4b; 5a, 5b) run between the ring element (3) and the main body (2) diverging from one another or matching vertically or horizontally.

3. Piston (1) from one of the preceding claims, wherein the dividing planes (4c, 5c) are aligned obliquely, or inclined.

4. Piston (1) from one of the preceding claims, wherein a vertically aligned dividing plane (5a) and a horizontally aligned dividing plane (4a) are provided between the ring element (3) and the main body (2).

5. Piston (1) from one of the preceding claims, wherein a height offset H results between the vertically aligned dividing plane (5a) assigned to the piston crown (10) and the horizontally aligned dividing plane (4a).

6. Piston (1) from one of the preceding claims, wherein the main body (2) forms a circumferential step (20) on the outside whose joining web (7b) running concentric to the longitudinal axis (11) of the piston (1) is enclosed at least in sections by the joining web (7a) of the ring element (3).

7. Piston (1) from one of the preceding claims, wherein the matching joining webs (6a, 6b; 7a, 7b; 21a, 21b) of the ring element (3) and the main body (2) are dimensioned at least approximately equal.

8. Piston (1) from one of the preceding claims, wherein the main body (2) and the ring element (3) are produced from a matching material or from different materials.

9. Method for producing a piston (1) for an internal combustion engine, configured as a cooling-gallery piston of two-piece construction that consists of a main body (2) and a ring element (3) in accordance with at least one of the claims 1 to 8, characterized by the following procedural steps:
Producing a main body (2) and a ring element (3) as forged or cast blanks by means of forging or casting or that are produced by stamping from a semi-finished material from a steel material;
Pre-machining of the main body (2) and the ring element (3) which includes introducing a combustion bowl (12) into the main body (2) and creating a ring belt;
Joining two matching joining webs (6a, 6b; 7a, 7b; 21a, 21b) of the main body (2) and the ring element (3), which respectively form a dividing plane (4a-4c; 5a-5c), by means of a material-to-material bond;
Finish or final machining of the piston (1).
